(19) United States
(12) Patent Application Publication
(10) Pub. No.: US 2019/0026290 A1
(43) Pub. Date: Jan. 24, 2019

(54) OPTIMIZATION METHOD, EVALUATION METHOD, AND PROCESSING METHOD AND APPARATUSES FOR DATA MIGRATION

(71) Applicant: ALIBABA GROUP HOLDING LIMITED, George Town (KY)

(72) Inventors: Yan HUANG, Hangzhou (CN); Le HE, Hangzhou (CN); Yingjie SHI, Hangzhou (CN); Jie ZHANG, Hangzhou (CN); Chen ZHANG, Hangzhou (CN)

(73) Assignee: ALIBABA GROUP HOLDING LIMITED

(21) Appl. No.: 16/140,435

(22) Filed: Sep. 24, 2018

Related U.S. Application Data
(63) Continuation of application No. PCT/CN2017/076037, filed on Mar. 9, 2017.

(30) Foreign Application Priority Data
Mar. 22, 2016 (CN) 201610166580.0

(51) Int. Cl. G06F 17/30; G06F 3/06; H04L 29/08

(52) U.S. Cl. CPC G06F 17/30079; G06F 3/0647; G06F 3/067; G06F 3/0605; H04L 29/0854

(57) ABSTRACT

The embodiments of the present disclosure provide an optimization method, an evaluation method, and a processing method, and apparatuses for data migration. The optimization method can include: generating a plurality of data migration solutions according to a principle, wherein the principle includes duplicating one or more target data unit with a first amount of depended data to a target cluster as to-be-duplicated data units and switching a computing cluster, and the first amount of depended data include depended data volumes of the target data unit; for each of the data migration solutions, determining bandwidth status data between clusters after switching the computing cluster; and performing a selection of the data migration solutions according to the bandwidth status data.

### CROSS REFERENCE TO RELATED APPLICATION

The disclosure claims the benefits of priority to International application number PCT/CN2017/076037, filed Mar. 9, 2017, which claims the benefits of priority to Chinese application number 201610166580.0, filed Mar. 22, 2016, both of which are incorporated herein by reference in their entireties.

### BACKGROUND

Conventionally, data migration includes duplicating all data units of a target project unit from a source cluster to a target cluster. During the duplication, all computing tasks related to the data units are still running in the source cluster. And after all the data units have been duplicated, the data migration can switch the computing tasks from the source cluster to the target cluster. For large-scale data migrations (for example, a project unit that contains a relatively large amount of data), the entire process can take a long time. Moreover, before the existing data is migrated, no evaluation can be performed based on a data dependence relationship. Therefore, the influence of the data dependence relationship on the bandwidth between clusters after migration cannot be considered.

These conventional systems have several problems. The generation of new data can bring problems. New data are frequently generated in some large-scale services, and the speed at which new data is generated is very high. However, conventionally, the computing tasks can be switched after all data is duplicated, which can result in very long migration time and extremely low migration efficiency. Meanwhile, the computing tasks are still running in the source cluster and can keep generating new data. If the speed of new data being generated is greater than the speed of data being migrated and duplicated (this situation also happens frequently), the migration task may never end unless the service stops generating new data.

The lack of evaluation based on the data dependence relationship can be problematic as well. Major problems are often discovered after data migration if no evaluation based on the data dependence relationship is performed before the migration. As complicated dependence relationship exists between data units, changes in the data access amount between clusters can be caused after the migration. If no sufficient evaluation is performed before migration, deterioration of network bandwidth between clusters may be caused after the migration.

### SUMMARY OF THE DISCLOSURE

Embodiments of the disclosure provide an optimization method for data migration. The method can include: generating a plurality of data migration solutions according to a principle, wherein the principle includes duplicating one or more target data units with a first amount of depended data to a target cluster as one or more to-be-duplicated data units and switching a computing cluster, and the first amount of depended data include depended data volumes of the target data units; for each of the data migration solutions, determining bandwidth status data between clusters after switching the computing cluster; and performing a selection of the data migration solutions according to the bandwidth status data.

In some embodiments, the one or more target data units belong to one or more target project units, and switching computing cluster comprises: switching computing tasks in the one or more target project units to the target cluster.

In some embodiments, determining the bandwidth status data between the clusters after switching the computing cluster further includes: acquiring current bandwidth usage data, the current bandwidth usage data being bandwidth usage data before switching the computing cluster; acquiring changed bandwidth usage data caused after switching the computing cluster according to a second amount of depended data of the one or more to-be-duplicated data units, wherein the second amount of depended data includes a depended data volume between the one or more to-be-duplicated data units and other data units outside the target cluster; and generating the bandwidth status data using the current bandwidth usage data and the changed bandwidth usage data.

In some embodiments, the bandwidth usage data includes sampling data of a bandwidth usage amount corresponding to a time point in a time period, and the bandwidth status data comprises a probability of full bandwidth.

In some embodiments, acquiring the current bandwidth usage data further includes: acquiring a current bandwidth usage amount; and sampling the current bandwidth usage amount in a pre-determined time period to generate first sampling data, wherein acquiring the changed bandwidth usage data further includes: generating second sampling data of a historical bandwidth usage amount corresponding to a time point in the time period according to historical data of the to-be-duplicated data units; and generating the bandwidth status data using the current bandwidth usage data and the changed bandwidth usage data includes: adding the first sampling data and the second sampling data to generate third sampling data, and determining the probability of full bandwidth based on the third sampling data.

In some embodiments, the probability of full bandwidth is equal to a time length when the bandwidth in the third sampling data exceeds a bandwidth upper limit divided by a time length of the time period.

In some embodiments, the method can further include: determining the probability of frill bandwidth of a data migration solution according to a probability threshold of full bandwidth, and rejecting the data migration solution, in response to the probability exceeding the probability threshold.

In some embodiments, before generating the plurality of data migration solutions, the method can further include: sorting the one or more target data units in a source cluster according to a size of the first amount of depended data.

In some embodiments, before sorting the one or more target data units in the source cluster according to the size of the first amount of depended data, the method can further include: acquiring the first amount of depended data according to historical data of the target data units.

In some embodiments, before sorting the one or more target data units in the source cluster according to the size of the first amount of depended data, the method can further include: determining bandwidth status data between clusters in a case of full volume data migration; and in response to the bandwidth status data failing to satisfy a bandwidth feasibility condition, ending the optimization method.

In some embodiments, generating the plurality of data migration solutions according to the principle can further include: duplicating all of a plurality of target data units at once; duplicating some of the plurality of the target data units; or duplicating, among the plurality of the target data units, a target data unit having a most amount of depended data.

In some embodiments, the method can further include: determining duplication time for duplicating the one or more to-be-duplicated data units under a duplication transmission bandwidth condition according to data volume of the one or more to-be-duplicated data units, and wherein performing the selection of the data migration solutions according to the bandwidth status data can further include: determining a data migration solution according to the bandwidth status data and the duplication time.

Embodiments of the disclosure further provide an evaluation method for data migration. The method can include: acquiring a second amount of depended data of one or more data units to be duplicated from a source cluster to a target cluster before switching a computing cluster, wherein the second amount of depended data is a depended data volume between the to-be-duplicated data units and other data units outside the target cluster; determining bandwidth status data between clusters after switching the computing cluster; and determining whether a data migration solution is feasible according to the bandwidth status data satisfying a bandwidth feasibility condition.

In some embodiments, the one or more data units belong to one or more target project units, and switching the computing cluster can further include: switching computing tasks in the one or more target project unit to the target cluster.

In some embodiments, determining the bandwidth status data between clusters after switching the computing cluster can further include: acquiring current bandwidth usage data, the current bandwidth usage data being bandwidth usage data before switching the computing cluster; acquiring changed bandwidth usage data caused after switching the computing cluster according to the second amount of depended data; and generating bandwidth status data using the current bandwidth usage data and the changed bandwidth usage data.

In some embodiments, the bandwidth usage data includes sampling data of a bandwidth usage amount corresponding to a time point in a time period, and the bandwidth status data further comprises a probability of full bandwidth.

In some embodiments, acquiring the current bandwidth usage data can further include: acquiring a current bandwidth usage amount; and sampling the current bandwidth usage amount in a time period to generate first sampling data, wherein acquiring the changed bandwidth usage data can further include: generating second sampling data of a historical bandwidth usage amount corresponding to a time point in the time period according to historical data related to the second amount of depended data, wherein generating the bandwidth status data using the current bandwidth usage data and the changed bandwidth usage data can further include: adding the first sampling data and the second sampling data to generate third sampling data; and determining the probability of full bandwidth based on the third sampling data from the addition.

In some embodiments, the probability of full bandwidth is equal to the time length when a bandwidth upper limit is exceeded in the third sampling data divided by the time length of the pre-determined time period.

In some embodiments, determining whether the data migration solution is feasible can further include: determining the probability of full bandwidth of a data migration solution according to a probability threshold of full bandwidth; in response to the probability of full bandwidth exceeding the probability threshold, determining that the data migration solution is infeasible; and in response to the probability of full bandwidth not exceeding the probability threshold, determining that the data migration solution is feasible.

In some embodiments, acquiring the second amount of depended data of the one or more data unit to be duplicated from the source cluster to the target cluster can further include: acquiring the second amount of depended data according to historical data of the to-be-duplicated data units.

Embodiments of the disclosure also provide a processing method for data migration. The method can also include: duplicating one or more target data units with a first amount of depended data to a target cluster as one or more to-be-duplicated data units, wherein the first amount of depended data includes all the depended data of the target data units; switching a computing cluster; and migrating remaining one or more target data units other than the first amount to the target cluster.

In some embodiments, the one or more target data units belong to one or more target project units, and switching the computing cluster can further include: switching all computing tasks in the one or more target project units to the target cluster.

In some embodiments, before duplicating the one or more target data units with a first amount of depended data to the target cluster as to-be-duplicated data units, the method can further include: sorting the one or more target data units in a source cluster according to a size of the first amount of depended data.

In some embodiments, before sorting the one or more target data units in a source cluster according to the size of the first amount of depended data, the method can further include: acquiring the first amount of depended data according to historical data of the target data units.

Embodiments of the disclosure further provide an optimization apparatus for data migration. The apparatus can include: a memory storing a set of instructions; and a processor configured to execute the set of instructions to cause the apparatus to: generate a plurality of data migration solutions according to a principle, wherein the principle includes duplicating one or more target data units with a first amount of depended data to a target cluster as to-be-duplicated data units and switching a computing cluster, and the first amount of depended data include depended data volumes of the target data units; for each of the data migration solutions, determine bandwidth status data between clusters after switching the computing cluster; and perform a selection of the data migration solutions according to the bandwidth status data.

In some embodiments, the one or more target data units belong to one or more target project units, and the processor is further configured to execute the set of instructions to switch computing tasks in the one or more target project units to the target cluster.

In some embodiments, the processor is further configured to execute the set of instructions to acquire current bandwidth usage data, the current bandwidth usage data being bandwidth usage data before switching the computing cluster; acquire changed bandwidth usage data caused after switching the computing cluster according to a second amount of depended data of the one or more to-be-duplicated data units, wherein the second amount of depended data includes a depended data volume between the one or more to-be-duplicated data units and other data units outside the target cluster; and generate the bandwidth status data using the current bandwidth usage data and the changed bandwidth usage data.

In some embodiments, the bandwidth usage data includes sampling data of a bandwidth usage amount corresponding to a time point in a time period, and the bandwidth status data comprises a probability of full bandwidth.

In some embodiments, the processor is further configured to execute the set of instructions to: acquire a current bandwidth usage amount; and sample the current bandwidth usage amount in a pre-determined time period to generate first sampling data, wherein the processor is further configured to execute the set of instructions to: generate second sampling data of a historical bandwidth usage amount corresponding to a time point in the time period according to historical data of the to-be-duplicated data units; and the processor is further configured to execute the set of instructions to: add the first sampling data and the second sampling data to generate third sampling data, and determine the probability of full bandwidth based on the third sampling data.

In some embodiments, the probability of full bandwidth is equal to a time length when the bandwidth in the third sampling data exceeds a bandwidth upper limit divided by a time length of the time period.

In some embodiments, the processor is further configured to execute the set of instructions to: determine the probability of full bandwidth of a data migration solution according to a preset probability threshold of full bandwidth, and reject the data migration solution, in response to the probability exceeding the probability threshold.

In some embodiments, the processor is further configured to execute the set of instructions to: sort the one or more target data units in a source cluster according to a size of the first amount of depended data.

In some embodiments, the processor is further configured to execute the set of instructions to: acquire the first amount of depended data according to historical data of the target data units.

In some embodiments, the processor is further configured to execute the set of instructions to: determine bandwidth status data between clusters in a case of full volume data migration; and in response to the bandwidth status data failing to satisfy a bandwidth feasibility condition, end the optimization method.

In some embodiments, the processor is further configured to execute the set of instructions to: duplicate all of a plurality of target data units at once; duplicate some of the plurality of the target data units; or duplicate, among the plurality of the target data units, a target data unit having a most amount of depended data.

In some embodiments, the processor is further configured to execute the set of instructions to: determine duplication time for duplicating the one or more to-be-duplicated data units under a duplication transmission bandwidth condition according to data volume of the one or more to-be-duplicated data units, and wherein the processor is further configured to execute the set of instructions to: determine a data migration solution according to the bandwidth status data and the duplication time.

Embodiments of the disclosure further provide an evaluation apparatus for data migration. The apparatus can include: a memory storing a set of instructions; and a processor configured to execute the set of instructions to cause the apparatus to acquire a second amount of depended data of one or more data units to be duplicated from a source cluster to a target cluster before switching a computing cluster, wherein the second amount of depended data is a depended data volume between the to-be-duplicated data units and other data units outside the target cluster; determine bandwidth status data between clusters after switching the computing cluster; and determine whether a data migration solution is feasible according to whether the bandwidth status data satisfies a bandwidth feasibility condition.

In some embodiments, the one or more data units belongs to one or more target project units, and the processor is further configured to execute the set of instructions to switch computing tasks in the one or more target project units to the target cluster.

In some embodiments, the processor is further configured to execute the set of instructions to: acquire current bandwidth usage data, the current bandwidth usage data being bandwidth usage data before switching the computing cluster; acquire changed bandwidth usage data caused after switching the computing cluster according to the second amount of depended data; and generate bandwidth status data using the current bandwidth usage data and the changed bandwidth usage data.

In some embodiments, the bandwidth usage data includes sampling data of a bandwidth usage amount corresponding to a time point in a time period, and the bandwidth status data further comprises a probability of full bandwidth.

In some embodiments, the processor is further configured to execute the set of instructions to: acquire a current bandwidth usage amount; and sample the current bandwidth usage amount in a time period to generate first sampling data, wherein the processor is further configured to execute the set of instructions to: generate second sampling data of a historical bandwidth usage amount corresponding to a time point in the time period according to historical data related to the second amount of depended data, wherein the processor is further configured to execute the set of instructions to: add the first sampling data and the second sampling data to generate third sampling data; and determine the probability of full bandwidth based on the third sampling data from the addition.

In some embodiments, the probability of full bandwidth is equal to the time length when a bandwidth upper limit is exceeded in the third sampling data divided by the time length of the pre-determined time period.

In some embodiments, the processor is further configured to execute the set of instructions to: determine the probability of full bandwidth of a data migration solution according to a probability threshold of full bandwidth; in response to the probability of full bandwidth exceeding the probability threshold, determine that the data migration solution is infeasible; and in response to the probability of full bandwidth not exceeding the probability threshold, determine that the data migration solution is feasible.

In some embodiments, the processor is further configured to execute the set of instructions to: acquire the second amount of depended data according to historical data of the to-be-duplicated data units.

Embodiments of the disclosure further provide a processing apparatus for data migration. The apparatus can include: a memory storing a set of instructions; and a processor configured to execute the set of instructions to cause the apparatus to duplicate one or more target data units with a first amount of depended data to a target cluster as to-be-duplicated data units, wherein the first amount of depended data includes all the depended data of the target data units; switch a computing cluster; and migrate remaining one or more target data units to the target cluster.

In some embodiments, the one or more target data units belong to one or more target project units, and the processor is further configured to execute the set of instructions to cause the apparatus to: switch all computing tasks in the one or more target project units to the target cluster.

In some embodiments, the processor is further configured to execute the set of instructions to cause the apparatus to: sort the one or more target data units in a source cluster according to a size of the first amount of depended data.

In some embodiments, the processor is further configured to execute the set of instructions to cause the apparatus to: acquire the first amount of depended data according to historical data of the target data units.

Embodiments of the disclosure further provide a non-transitory computer readable medium that stores a set of instructions that is executable by at least one processor of a computer system to cause the computer system to perform an optimization method for data migration. The method can include: generating a plurality of data migration solutions according to a principle, wherein the principle includes duplicating one or more target data units with a first amount of depended data to a target cluster as to-be-duplicated data units and switching a computing cluster, and the first amount of depended data include depended data volumes of the target data units; for each of the data migration solutions, determining bandwidth status data between clusters after switching the computing cluster; and performing a selection of the data migration solutions according to the bandwidth status data.

Embodiments of the disclosure further provide a non-transitory computer readable medium that stores a set of instructions that is executable by at least one processor of a computer system to cause the computer system to perform an evaluation method for data migration. The method can include: acquiring a second amount of depended data of one or more data units to be duplicated from a source cluster to a target cluster before switching a computing cluster, wherein the second amount of depended data is a depended data volume between the to-be-duplicated data units and other data units outside the target cluster; determining bandwidth status data between clusters after switching the computing cluster; and determining whether a data migration solution is feasible according to whether the bandwidth status data satisfies a bandwidth feasibility condition.

Embodiments of the disclosure further provide a non-transitory computer readable medium that stores a set of instructions that is executable by at least one processor of a computer system to cause the computer system to perform a processing method for data migration. The method can include: duplicating one or more target data units with a first amount of depended data to a target cluster as to-be-duplicated data units, wherein the first amount of depended data includes all the depended data of the target data units; switching a computing cluster; and migrating remaining one or more target data units to the target cluster.

### BRIEF DESCRIPTION OF THE DRAWINGS

FIG. 1 is a schematic diagram of an exemplary data migration method, according to some embodiments of the disclosure.

FIG. 2 is a schematic diagram of another exemplary data migration method, according to some embodiments of the disclosure.

FIG. 3 is a flowchart of an exemplary optimization method for data migration, according to some embodiments of the disclosure.

FIG. 4 is a flowchart of another exemplary optimization method for data migration, according to some embodiments of the disclosure.

FIG. 5 is a schematic diagram of a curve of a current bandwidth usage amount collected by a bandwidth monitoring device, according to some embodiments of the disclosure.

FIG. 6 is a schematic diagram of a curve of a bandwidth usage amount after addition, according to some embodiments of the disclosure.

FIG. 7 is a schematic diagram of a curve generated according to a duplication time and a probability of full bandwidth corresponding to each data migration solution, according to some embodiments of the disclosure.

FIG. 8 is a flowchart of an evaluation method for data migration, according to some embodiments of the disclosure.

FIG. 9 is a flowchart of a processing method for data migration, according to some embodiments of the disclosure.

FIG. 10 is a block diagram of an optimization apparatus for data migration, according to some embodiments of the disclosure.

FIG. 11 is a block diagram of an evaluation apparatus for data migration, according to some embodiments of the disclosure.

FIG. 12 is a block diagram of a processing apparatus for data migration, according to some embodiments of the disclosure.

### DETAILED DESCRIPTION

Exemplary embodiments of the present disclosure will be described in more detail below with reference to the accompanying drawings. Although exemplary embodiments of the present disclosure are shown in the accompanying drawings, it should be understood that the present disclosure can be implemented in various ways and should not be limited by the embodiments illustrated herein. On the contrary, these embodiments are provided for the purpose of understanding the present disclosure more thoroughly, and completely conveying the scope of the present disclosure to a person skilled in the art.

Data migration involves migrating one or more project units from a source cluster to a target cluster, in which the project unit contains at least one data unit and at least one computing task. The data unit can be a data sheet or a collection unit composed of multiple data sheets. Therefore, data migration can also be considered as migrating one or more data units and one or more computing tasks corresponding to these data units from the source cluster to the target cluster. In addition, the cluster can be considered as a group of computer group systems that work in cooperation to provide unified service to the outside world.

Data migration involves the tasks of transferring data units and switching computer clusters.

Regarding the transfer task, the data units in each project unit in the source cluster may be transferred into the target cluster. Generally, the data units can be duplicated from the source cluster to the target cluster, while the computing tasks are still working in the source cluster.

Regarding the switching task, some or all computing tasks of each project unit can be switched from the source cluster to the target cluster. It is appreciated that, this process does not involve data transmission. After switching, all computing tasks can run in the target cluster, and the new data generated can also be stored in the target cluster.

Data migration can also involve a dependence relationship between data units. After data migration is completed, the network bandwidth between the target cluster and other clusters can be affected as a result of the dependence relationship. The network bandwidth refers to the amount of information flowing from one end to another end in a time period. The network bandwidth can also be referred to as data transmission rate and is an important indicator for measuring the network usage condition.

The dependence relationship between data can be generated by an input/output relationship of the computing tasks. For example, a first data unit is an input of a certain computing task, while a second data unit is an output to the computing task. Then it is defined that the second data unit depends on the first data unit. Therefore, a dependence relationship is determined by a data input/output relationship of a computing task. For the first data unit, the dependence relationship can be reflected in the following fact: the computing tasks need to read the data in the first data unit to output data to the second data unit.

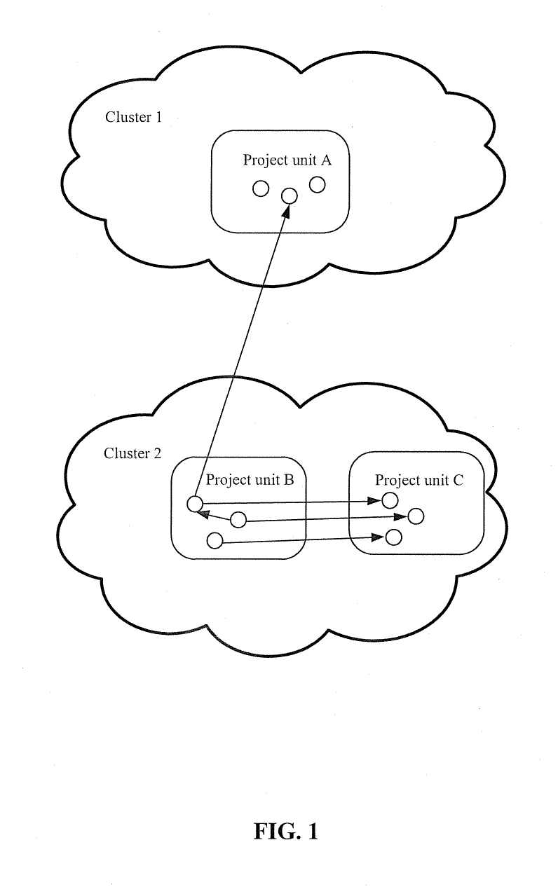

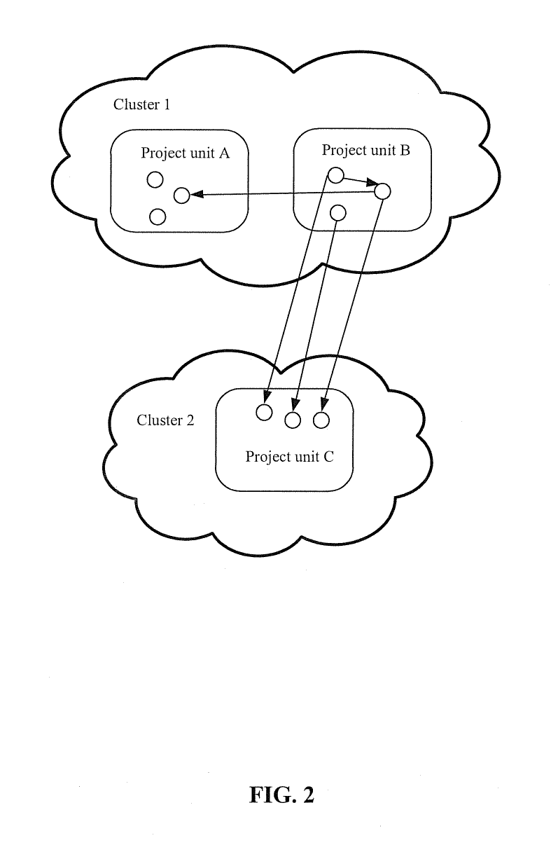

The influence of the dependence relationship between data on data migration is further explained below through FIG. 1 and FIG. 2. As shown in FIG. 1 and FIG. 2 below, the circles in the drawings represent data units in project units, and the lines in the drawings represent the dependence relationship between the data units.

As can be seen from the drawings, there are more dependence relationships between data units in project unit B and project unit C, while there are fewer dependence relationships between data units in project unit B and project unit A. Therefore, computing tasks in project unit B can access the data units in project unit C more, thereby producing a higher data access amount. In FIG. 1, as project units B and C are in a same cluster, the data access amount between project unit B and project unit C will not occupy the bandwidth between clusters. Moreover, in FIG. 1 and FIG. 2, the dependence relationship between data units inside project unit B will not affect the bandwidth either.

If project unit B is migrated from cluster 2 to cluster 1, the result of the migration is as shown in FIG. 2. The following changes can be seen from the figure: the data access amount between project unit B and project unit C will occupy the bandwidth between cluster 1 and cluster 2, and the data access amount between project unit A and project unit B will no longer occupy the bandwidth between the clusters. Since the data access amount between project unit B and project unit C is obviously greater than the data access amount between project unit B and project unit A, the data access amount between cluster 1 and cluster 2 increases and occupies more bandwidth than the situation in FIG. 1. If project unit B is rashly migrated from cluster 2 to cluster 1, it may cause the bandwidth between cluster 1 and cluster 2 to be full, and lead to deterioration of the network environment.

It can be seen that, due to the presence of dependence relationships, data migration can have greater effect on the network environment between clusters, especially the bandwidth.

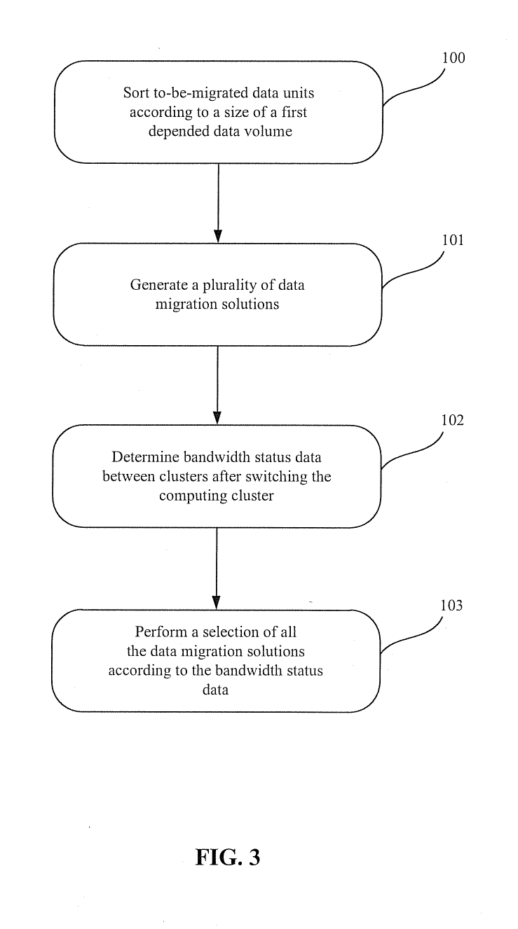

FIG. 3 is a flowchart of an exemplary optimization method for data migration, according to embodiments of the disclosure. The optimization method includes steps 101-103 as below.

In step 101, a plurality of data migration solutions can be generated according to a principle. The principle can include duplicating one or more target data units with a first amount of depended data to a target cluster as to-be-duplicated data units and switching a computing cluster. The first amount of depended data refers to, among the target data units, an amount of data that is being depended. The first amount of depended data may include depended data volume inside a same project unit, and may also include depended data volume of other project units except for the project unit where the data units are located. The first amount of depended data may further include a depended data volume across clusters. In addition, the switching of the computing cluster refers switching some or all computing tasks associated with the target data units to a target cluster. It is appreciated that the relationship between computing tasks and data units is merely a data access relationship, and this data access relationship does not require the computing tasks and the data units to be in a same computing cluster.

In the above-mentioned principle, all the target data units can be divided into two parts, including a first part of data units (referred to as hot data units) to be preferentially duplicated before the computing cluster is switched, and a second part of data units (referred to as cold data units) to be gradually duplicated to the target cluster after the computing cluster is switched. The migration of the cold data units can be completed in a way other than concentrated duplication, and therefore, can be considered to occupy little bandwidth between clusters. For example, through an underlying data transmission mechanism between clusters, duplication may be performed in an idle time period of the cluster system.

It is possible that, a number of to-be-duplicated data units is equal to a number of target data units. Therefore, the data migration solution is a full volume migration solution.

In addition, when selecting which data units are to be duplicated, a life cycle of the data units can also be considered. The life cycle refers to an effective existence time of a data unit. For example, many data may be temporarily accessed, and after a preset period of time, it no longer has value in existence and can be deleted. Therefore, during duplication, the life cycle of the data can be determined. These data units that have already been beyond their life cycle or their life cycle is going to end can be removed from the list of to-be-duplicated data units. Therefore, the efficiency of data migration can be further improved and the duplication of useless data units can be avoided.

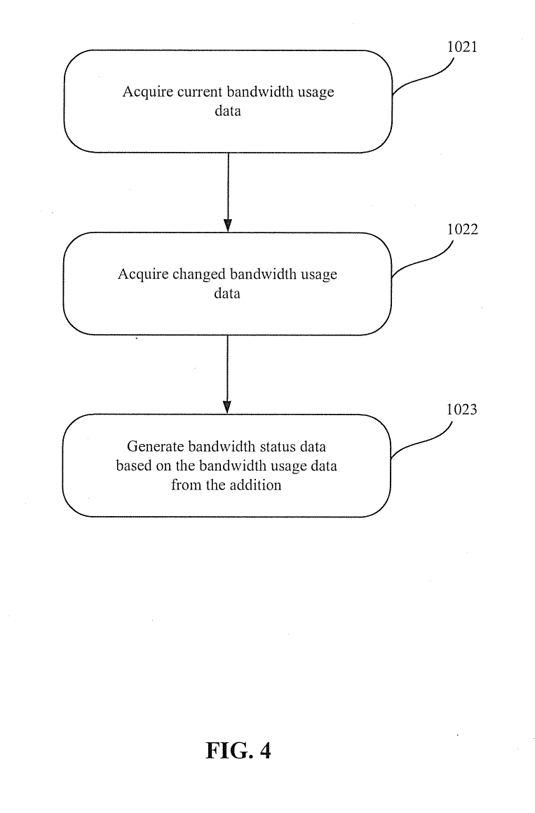

In step 102, for each data migration solution, bandwidth status data between the clusters after switching the computing cluster can be determined. The bandwidth status data can include current bandwidth usage data and changed bandwidth usage data caused by the hot data units. In some embodiments, FIG. 4 is a flowchart of another exemplary optimization method for data migration, according to embodiments of the disclosure. As shown in FIG. 4, the process of determining bandwidth status data between the clusters after switching the computing cluster can further include steps 1021-1023.

In step 1021, current bandwidth usage data can be acquired. The current bandwidth usage data here is bandwidth usage data before switching the computing cluster.

In step 1022, changed bandwidth usage data after switching the computing cluster can be acquired according to a second amount of depended data of the one or more to-be-duplicated data units. The second amount of depended data is a depended data volume between the one or more to-be-duplicated data units and other data units outside the target cluster. The second depended data volume here is the depended data volume that only affects the bandwidth between the clusters.

In step 1023, the current bandwidth usage data can be added to the changed bandwidth usage data, to generate bandwidth status data.

With reference back to FIG. 3, in step 103, optimized selection can be performed on the data migration solutions according to the bandwidth status data.

The above-mentioned multiple target data units generally belong to one or more target project units. The above-mentioned operation of switching the computing cluster can include switching all computing tasks in the one or more target project units to a target cluster.

In addition, before the above-mentioned step 101, the method can further include a step 100.

In step 100, a plurality of target data units in a source cluster can be sorted according to a size of a first amount of depended data. The first amount of depended data of each target data unit can be acquired from historical data corresponding to each target data unit. A system log can include access record information about the data, and the above-mentioned first amount of depended data can be acquired according to these pieces of access record information.

For example, to migrate project unit P1 (see P1 in the table below) and project unit P2 (see P2 in the table below) from a source cluster to a target cluster, the first amount of depended data of each data sheet (T1 to T8) and the size of each data sheet itself in project unit P1 and project unit P2 can be acquired and sorted according to the first amount of depended data, as in Table 1 below.

TABLE 1

| | | First amount of | Size of data |
|---|---|---|---|
| Project unit | Data sheet | depended data (TB) | sheet (TB) |
| P1 | T1 | 604.0587748 | 509.2679144 |
| P1 | T2 | 273.622409 | 5809.682572 |
| P1 | T3 | 155.7736591 | 2592.183048 |
| P2 | T4 | 109.7930397 | 294.316627 |
| P1 | T5 | 85.295671 | 1.581307012 |
| P1 | T6 | 65.62373626 | 181.4551872 |
| P2 | T7 | 28.8274278 | 81.43424138 |
| P2 | T8 | 24.71642052 | 15.24111635 |

It is appreciated that in the above-mentioned flow, step 102 can be performed after a plurality of migration solutions have been generated in the above-mentioned step 101. However, it is appreciated that the operation of determining the bandwidth status data in step 102 can also be performed after one data migration solution is produced in step 102, without waiting for the generation of all of the plurality of data migration solutions. Alternatively, it is also possible to generate a plurality of data migration solutions by way of loop traversal according to the sorting of the target data units in step 100 and according to the principle in step 101, starting from duplicating all the target data units once, with one data unit being decreased progressively at a time, until only duplicating the target data unit with the most first amount of depended data (reverse progressive increase is also applicable).

Explanation is made in more detail below with regard to two aspects: how to determine bandwidth status data between clusters after switching the computing cluster and how to perform optimized evaluation on solutions.

(1) Calculation of Bandwidth Status Data

In the above-mentioned steps, the bandwidth usage data can be sampling data of a bandwidth usage amount corresponding to a time point in a pre-determined time period, and the bandwidth status data can be the probability of full bandwidth.

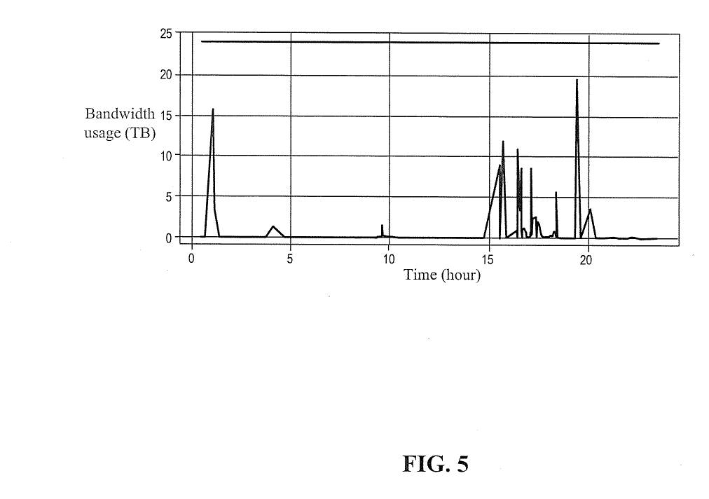

Further, the above-mentioned step 1021 can further include: acquiring a current bandwidth usage amount, and sampling the current bandwidth usage amount in a pre-determined time period to generate first sampling data. The current bandwidth usage amount can be obtained by way of monitoring and recording through bandwidth monitoring devices. FIG. 5 is a schematic diagram of a curve of a current bandwidth usage amount collected by a bandwidth monitoring device, according to some embodiments of the disclosure. The horizontal axis of FIG. 5 indicates time with hour as a unit, and the vertical axis indicates a bandwidth usage amount with TB (terabyte) as a unit. The above-mentioned first sampling data can be obtained through sampling the diagram. The horizontal line from the upper part of the diagram is the bandwidth upper limit, and if the bandwidth usage amount exceeds the upper limit value, the bandwidth is considered to be full.

The above-mentioned step 1022 can further include: generating second sampling data of a historical bandwidth usage amount corresponding to a time point in a pre-determined time period, according to historical data related to the second amount of depended data. Access records of the data units are recorded in the history log. By querying the records in the history log, information associated with the second amount of depended data can be filtered out, and then counting and sampling can be performed to generate the above-mentioned second sampling data.

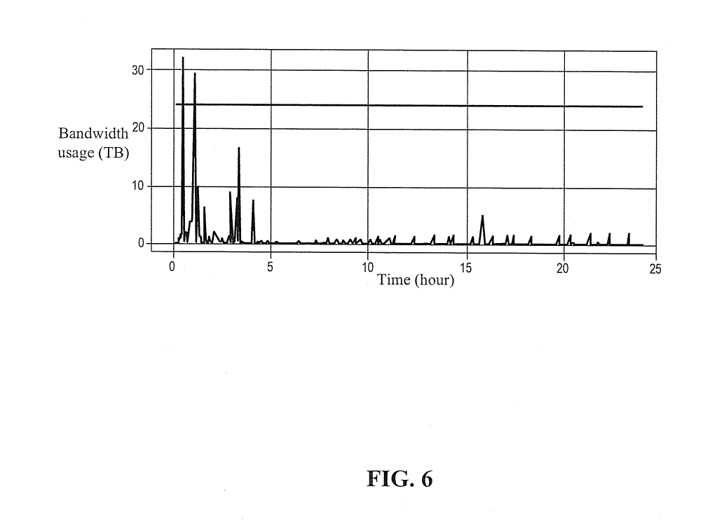

The above-mentioned step 1023 can further include: adding the first sampling data to the second sampling data, and determining the probability of full bandwidth based on third sampling data from the addition. FIG. 6 is a schematic diagram of a curve of a bandwidth usage amount after addition, according to embodiments of the disclosure. It can be seen that in some parts of the time period, the bandwidth usage amount can exceed the bandwidth upper limit, which indicates the situation of full bandwidth.

The formula for determining the probability of full bandwidth can be as below.

P=TM1/TM2 Formula (1):

Here, P represents the probability of full bandwidth, TM1 represents the length of time when the bandwidth in the third sampling data exceeds the bandwidth upper limit, and TM2 represents the time length of a pre-determined time period. In some embodiments, TM1 and TM2 can be counted with minute as a unit.

The pre-determined time period in the above step 1021 and step 1022 can be a fixed time period of each day. For example, counting and sampling can be performed according to historical data or bandwidth monitoring data of 00:00 to 09:00 each day in the last N days (for example, 30 days), to respectively generate first sampling data and second sampling data, and then to determine the probability of full bandwidth in the time period according to third sampling data from the addition.

(2) How to Perform Optimized Evaluation on Solutions

After determining the bandwidth status data as above, the solutions can be filtered according to the advantages and disadvantages of the bandwidth status data. For example, a solution with lower probability of full bandwidth can be selected. In addition, after predicting the probability of full bandwidth for a data migration solution, a probability of full bandwidth can also be determined according to a preset condition. If the probability of full bandwidth is too high, then it is considered that the data migration solution is not feasible at all, and the data migration solution can be abandoned. For example, the probability threshold of full bandwidth can be set to 95%. If the predicted probability of full bandwidth exceeds 95%, then the data migration solution can be abandoned.

In addition, before starting the above-mentioned optimization method for data migration, predictive evaluation of the bandwidth status data can be performed for a full volume migration solution. The evaluation can include determining the bandwidth status data between clusters in the case of full volume data migration. If the bandwidth status data does not satisfy a preset bandwidth feasibility condition (for example, the probability of full bandwidth is too high), then it is considered that all the migration solutions are infeasible. It is appreciated that, no matter which migration solution it is, the only difference lies in how to duplicate the data unit. But at last, all solutions will complete full volume migration. Therefore, the flow of the optimization method can be terminated.

In addition, in some embodiments, optimized selection can be performed on the solutions in conjunction with the duplication time consumed for duplicating the above-mentioned to-be-duplicated data units before switching the computing cluster. Therefore, the probability of full bandwidth and the duplication time can be considered comprehensively to determine the optimized solution.

The duplication time can be determined according to given duplication transmission bandwidth conditions and data volume of the to-be-duplicated data units themselves. For example, the bandwidth for data migration can be given in advance, and then the duplication time can be determined according to the size of the duplicated unit and the given bandwidth. If days are taken as the units, the following formula is generated.

Duplication days=data volume of the to-be-duplicated data unit/bandwidth for data migration/3600/24.

Because the bandwidth is generally expressed with “data volume/second” as the unit, the formula is divided by 3,600 to obtain the number of hours used, and then is divided by 24 to convert hours to days.

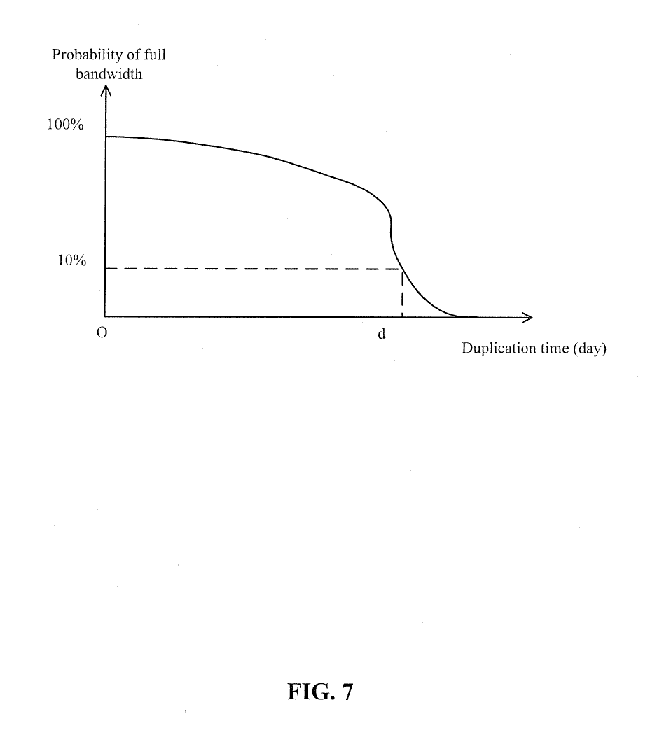

FIG. 7 is a schematic diagram of a curve generated according to a duplication time and a probability of full bandwidth corresponding to each data migration solution, according to embodiments of the disclosure. For example, based on the duplication time and the probability of full bandwidth, it is considered that when the duplication time is d days, the probability of full bandwidth is 10% (which is relatively low), therefore, the data migration solution corresponding to the dot on the curve is selected. It is also possible to take the switching of the computing cluster as soon as possible as a primary condition for consideration, and the data migration solution with shorter duplication time and higher probability of full bandwidth may then be selected.

The optimization method for data migration can generate a plurality of data migration solutions according to the principle of preferentially duplicating hot data units and then switching the computing cluster. The optimization method can then make a comprehensive determination based on the probability of full bandwidth and the duplication time, and select a data migration solution, thereby greatly improving the efficiency of data migration and reducing the risk of data migration failure.

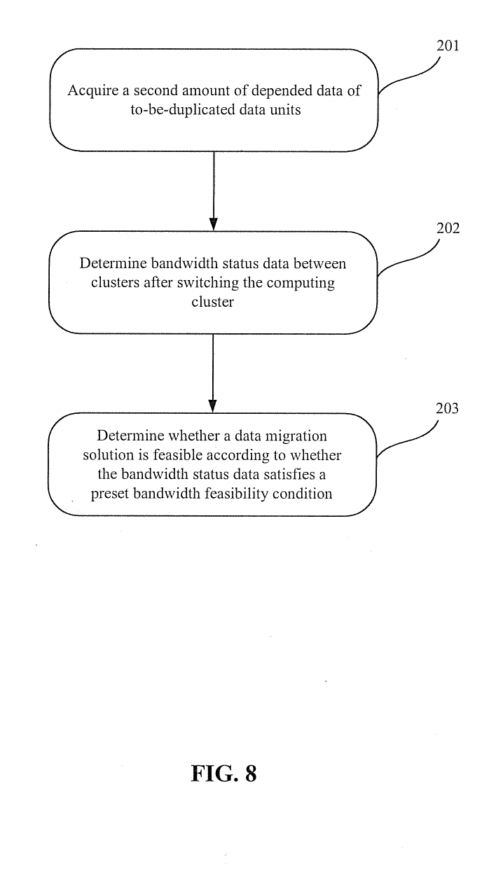

Some embodiments of the disclosure also are also directed to an evaluation method for data migration. The method can be used for performing simulated evaluation on a data migration solution before a data migration operation is carried out, to determine its feasibility. FIG. 8 is a flowchart of an evaluation method for data migration, according to embodiments of the disclosure. The evaluation method can include steps 201-203.

In step 201, a second amount of depended data of one or more data units to be duplicated from a source cluster to a target cluster before switching a computing cluster can be acquired. The second amount of depended data is consistent with the meaning in the above-mentioned embodiment. That is, the second amount of depended data refers to depended data volume between the to-be-duplicated data units and other data units outside the target cluster. In step 201, the to-be-duplicated data units can either be all of the target data units to be migrated, or some of the target data units to be migrated. Therefore, the evaluation apparatus can evaluate the full volume migration solution and can also evaluate a solution in which some hot data units are migrated first, switch the computing cluster, and migrate cold data units.

In step 202, bandwidth status data between clusters after switching the computing cluster can be determined. The step can correspond to steps 1021-1023 in the above-mentioned embodiments. Further, the bandwidth usage data can be sampling data of a bandwidth usage amount corresponding to a time point in a pre-determined time period, and the bandwidth status data can include the probability of full bandwidth. Similar description of the above embodiments will be omitted herein.

In step 203, whether a data migration solution is feasible can be determined according to whether the bandwidth status data satisfies a preset bandwidth feasibility condition. For example, it is possible to determine the probability of full bandwidth of the data migration solution according to a preset probability threshold of full bandwidth, and if it exceeds the probability threshold, then the data migration solution can be determined to be infeasible; otherwise, the data migration solution is feasible.

The evaluation method for data migration according to embodiments of the present disclosure can be applied before a migration operation is carried out, The evaluation method can perform simulated evaluation on the network bandwidth state based on the depended data volume of the to-be-duplicated data unit, and determine whether the solution is feasible according to the bandwidth status data, thereby reducing the risk of data migration failure.

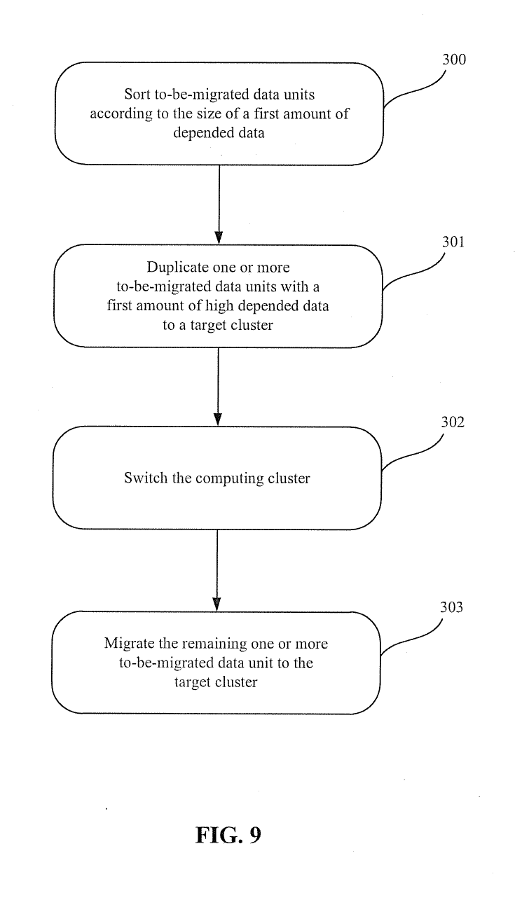

Embodiments of the disclosure can be further directed to a processing method for data migration. FIG. 9 is a flowchart of an exemplary processing method for data migration, according to some embodiments of the disclosure. The processing method can include steps 301-303.

In step 301, one or more target data units with a first amount of depended data can be duplicated to a target cluster as to-be-duplicated data units, wherein the first amount of depended data includes all the depended data volumes of the target data units.

In step 302: the computing cluster can be switched. The operation of switching the computing cluster can include switching all computing tasks in the one or more target project units to a target cluster. After switching the computing cluster, new data generated by computing tasks can be stored in the target cluster by default.

In step 303, the remaining one or more target data units can be migrated to the target cluster.

Before the above-mentioned step 301, the method can further include step 300. In step 300, the plurality of target data units in a source cluster can be sorted according to the first amount of depended data. The plurality of target data units can belong to one or more target project units. For example, before step 300, the first amount of depended data can be obtained according to statistics about historical data of the target data units.

In addition, before implementing the processing method for data migration, the evaluation method can be applied to determine the feasibility of the migration solution, and the optimization method for data migration can also be applied to select a more reasonable data migration solution to perform data migration.

By duplicating hot data units with a high amount of depended data, switching a computing cluster, and migrating the cold data units, the processing method for data migration according to embodiments of the present disclosure can complete the switching of the computing cluster as soon as possible, thereby improving the efficiency of data migration. As new data generated after switching the computing cluster can be stored in the target cluster, the influence brought by the continual generation of new data is also solved.

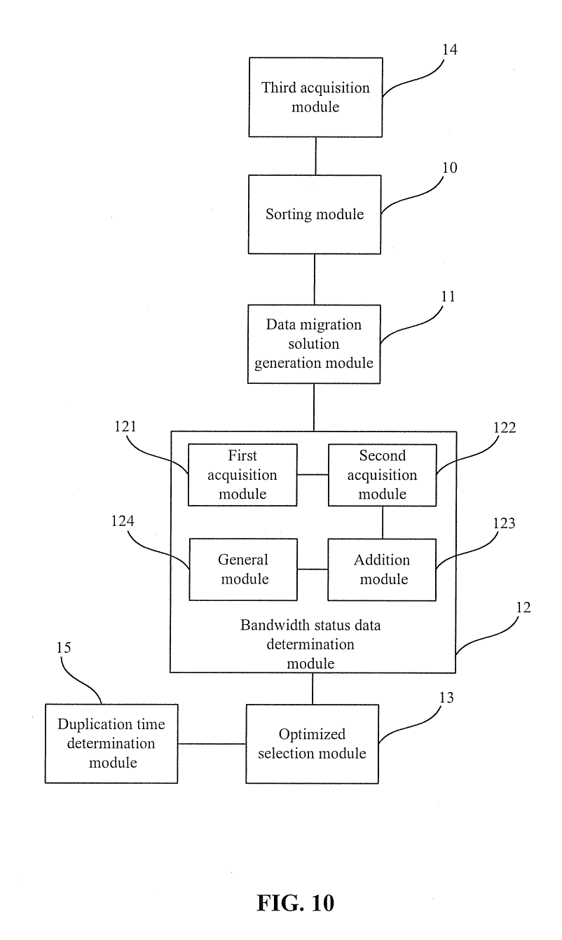

FIG. 10 is a block diagram of an exemplary optimization apparatus for data migration, according to some embodiments of the disclosure. The optimization apparatus includes a data migration solution generation module 11, a bandwidth status data determination module 12, and an optimized selection module 13.

Data migration solution generation module 11 can generate a plurality of data migration solutions according to a principle. The principle can include duplicating one or more target data units with a high first amount of depended data to a target cluster as to-be-duplicated data units and switching a computing cluster, and triggering bandwidth status data determination module 12 to determine and process each of the data migration solutions. The first amount of depended data can include all the depended data volumes of the target data units.

Bandwidth status data calculation module 12 can determine bandwidth status data between clusters after the computing cluster is switched.

Optimized selection module 13 can perform optimized selection on all the data migration solutions according to the bandwidth status data.

The optimization apparatus can further include: a sorting module 10 for sorting the plurality of target data units in a source cluster according to the size of the first amount of depended data. The plurality of target data units can belong to one or more target project units. Correspondingly, the switching of the computing cluster can include switching all computing tasks in the one or more target project units to the target cluster. In addition, the optimization apparatus can further include: a third acquisition module 14 for acquiring the first amount of depended data according to historical data of the target data units.

Bandwidth status data determination module 12 can further include: a first acquisition module 121, a second acquisition module 122, an addition module 123, and a generation module 124.

First acquisition module 121 can acquire current bandwidth usage data, wherein the current bandwidth usage data is bandwidth usage data before the computing cluster is switched.

Second acquisition module 122 can acquire changed bandwidth usage data caused after the computing cluster is switched according to a second depended data volume of the one or more to-be-duplicated data units, wherein the second depended data volume is a depended data volume between the one or more to-be-duplicated data units and other data units outside the target cluster.

Addition module 123 can add the current bandwidth usage data to the changed bandwidth usage data and generating bandwidth usage data from the addition; and

Generation module 124 can generate bandwidth status data based on the bandwidth usage data from the addition.

The above-mentioned bandwidth usage data can be sampling data of a bandwidth usage amount corresponding to a time point in a pre-determined time period, and the bandwidth status data can include the probability of full bandwidth.

Above-mentioned first acquisition module 121 can further acquire a current bandwidth usage amount and sample the current bandwidth usage amount in a pre-determined time period to generate first sampling data, so as to acquire the current bandwidth usage data.

Above-mentioned second acquisition module 122 can further: generate second sampling data of a historical bandwidth usage amount corresponding to a time point in the pre-determined time period, according to historical data of the to-be-duplicated data unit.

Above-mentioned addition module 123 can further add the first sampling data to the second sampling data to generate third sampling data from the addition.

Above-mentioned generation module 124 can further determine the probability of full bandwidth based on the third sampling data from the addition. The probability of full bandwidth can be calculated using the above-mentioned formula (1).

In addition, the optimization apparatus for data migration can further include: a duplication time determination module 15 for determining duplication time for duplicating the one or more to-be-duplicated data units in a given duplication transmission bandwidth condition according to data volume of the one or more to-be-duplicated data units themselves. Correspondingly, in the optimized selection module, the optimized selection being performed on the data migration solutions according to the bandwidth status data further includes: comprehensively determining a data migration solution according to the bandwidth status data and the duplication time.

Further, the optimization apparatus for data migration can further include: a data migration solution filtering module for determining a probability of full bandwidth of a data migration solution according to a preset probability threshold of full bandwidth, and if the probability of full bandwidth exceeds the probability threshold, rejecting the data migration solution.

In addition, the optimization apparatus for data migration can further include: a full volume migration evaluation module for determining the bandwidth status data between clusters in a case of full volume data migration before the optimization processing, and if the bandwidth status data does not satisfy a preset bandwidth feasibility condition, then stopping optimization processing of the data migration solution.

By generating a plurality of migration solutions according to the principle of preferentially duplicating hot data units with a high depended data volume and then switching a computing cluster, performing predictive evaluation on each of the solutions based on bandwidth status data, and then performing optimized selection, the optimization apparatus for data migration according to the embodiments of the present disclosure can obtain a data migration solution, the efficiency of data migration can be improved, and the risk of data migration failure can be reduced.

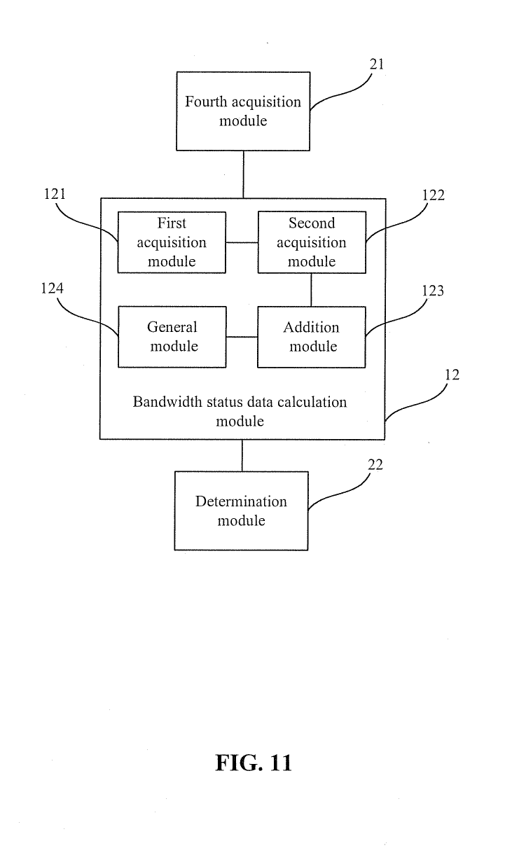

FIG. 11 is a block diagram of an exemplary evaluation apparatus for data migration, according to solve embodiments of the disclosure. The evaluation apparatus includes a fourth acquisition module 21, a bandwidth status data determination module 12, and a determination module 22.

Fourth acquisition module 21 can acquire a second amount of depended data of one or more data units to be duplicated from a source cluster to a target cluster before a computing cluster is switched. For example, the second amount of depended data can be acquired according to historical data of the to-be-duplicated data units. The second amount of depended data is the depended data volume between the to-be-duplicated data units and other data units outside the target cluster. The to-be-duplicated data units can either be all the target data units that need to be migrated or some of the target data units that need to be migrated. That is, the evaluation apparatus of this embodiment can evaluate the full volume migration solution and can also evaluate a solution in which some hot data is migrated first, and then the computing cluster is switched, and finally cold data is migrated.

Bandwidth status data determination module 12 can determine bandwidth status data between clusters after the computing cluster is switched.

Determination module 22 can determine whether a data migration solution is feasible according to whether the bandwidth status data satisfies a preset bandwidth feasibility condition.

Above-mentioned bandwidth status data determination module 12 can further include: a first acquisition module 121, a second acquisition module 122, an addition module 123, and a generation module 124.

First acquisition module 121 can acquire current bandwidth usage data.

Second acquisition module 122 can acquire changed bandwidth usage data caused after the computing cluster is switched according to the second depended data volume of the one or more to-be-duplicated data units.

Addition module 123 can add the current bandwidth usage data and the changed bandwidth usage data to generate bandwidth usage data.

Generation module 124 can generate bandwidth status data based on the generated bandwidth usage data.

The above-mentioned bandwidth usage data can include sampling data of a bandwidth usage amount corresponding to a time point in a pre-determined time period, and the bandwidth status data can also include the probability of full bandwidth.

Above-mentioned first acquisition module 121 can further acquire a current bandwidth usage amount, and sample the current bandwidth usage amount in a pre-determined time period to generate first sampling data.

Above-mentioned second acquisition module 122 can further generate second sampling data of a historical bandwidth usage amount corresponding to a time point in the pre-determined time period, according to historical data of the to-be-duplicated data unit.

Above-mentioned addition module 123 can further add the first sampling data to the second sampling data to generate third sampling data from the addition.

Above-mentioned generation module 124 can further determine the probability of full bandwidth based on the third sampling data from the addition. The probability of full bandwidth can be determined using the above-mentioned formula (1).

Further, to determine whether a data migration solution is feasible according to whether the bandwidth status data satisfies a preset bandwidth condition, above-mentioned determination module 22 can further determine the probability of full bandwidth of the data migration solution according to a preset probability threshold of full bandwidth, and determine that the data migration solution is infeasible, if the probability exceeds the probability threshold. Otherwise, determination module 22 can determine the solution is feasible.

The evaluation apparatus for data migration according to embodiments of the present disclosure can be applied before an actual data migration operation is carried out, so as to perform simulated evaluation on the network bandwidth state based on the depended data volume of the to-be-duplicated data unit, and finally determine whether the solution is feasible according to the bandwidth status data, thereby reducing the risk of data migration failure.

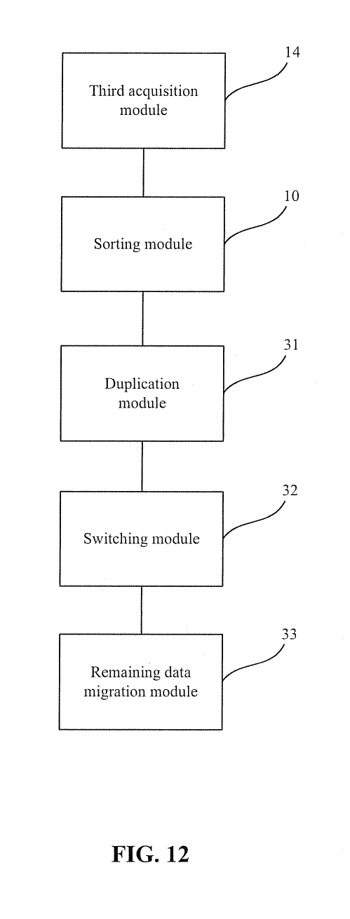

FIG. 12 is a block diagram of an exemplary processing apparatus for data migration, according to some embodiments of the disclosure. The processing apparatus includes a duplication module 31, a switching module 32, and a remaining data migration module 33.

Duplication module 31 can preferentially duplicate one or more target data units with a relatively high first amount of depended data to a target cluster as to-be-duplicated data units, wherein the first amount of depended data is all the depended data volumes of the target data units.

Switching module 32 can switch a computing cluster.

Remaining data migration module 33 can migrate the remaining one or more target data units to the target cluster.

The processing apparatus can further include: a sorting module 11 for sorting the plurality of target data units in a source cluster according to the size of the first amount of depended data. The plurality of target data units can belong to one or more target project units. Correspondingly, the switching of the computing cluster can specifically be switching all computing tasks in the one or more target project units to the target cluster.

Further, the processing apparatus can further include: a third acquisition module 14 for acquiring the first amount of depended data according to historical data of the target data units.

By duplicating hot data units with a high depended data volume, switching a computing cluster, and migrating cold data units, the processing apparatus for data migration can complete the switching of the computing cluster as soon as possible, thereby improving the efficiency of data migration. As new data generated after switching the computing cluster will be stored in the target cluster, the influence brought by the continual generation of new data is also solved.

It is appreciated that some or all steps for implementing the above-mentioned method embodiments can be completed through a program instructing related hardware. The aforementioned program can be stored in one computer readable storage medium. When the program is executed, steps included in the above-mentioned method embodiments are performed; and the aforementioned storage medium includes various media that can store program codes, such as ROM, RAM, magnetic disk or optical disk.

It is further appreciated that the above embodiments are merely for the explanation of the technical solution of the present disclosure, instead of limitation. Although detailed explanation is made to the present invention with reference to the aforementioned embodiments, a person of ordinary skill in the art should understand that he/she can still make modifications to the technical solution recorded in the aforementioned embodiments or make equivalent substitutions to some or all technical features, and these modifications or substitutions do not make the essence of the corresponding technical solution depart from the scope of the technical solution according to the embodiments of the present disclosure.

1. An optimization method for data migration, comprising:
generating a plurality of data migration solutions according to a principle, wherein the principle includes duplicating one or more target data units with a first amount of depended data to a target cluster as one or more to-be-duplicated data units and switching a computing cluster, and the first amount of depended data include depended data volumes of the target data units;
for each of the data migration solutions, determining bandwidth status data between clusters after switching the computing cluster; and
performing a selection of the data migration solutions according to the bandwidth status data.

2. The optimization method according to claim 1, wherein the one or more target data units belong to one or more target project units, and switching computing cluster comprises: switching computing tasks in the one or more target project units to the target cluster.

3. The optimization method according to claim 1, wherein determining the bandwidth status data between the clusters after switching the computing cluster further comprises:
acquiring current bandwidth usage data, the current bandwidth usage data being bandwidth usage data before switching the computing cluster;
acquiring changed bandwidth usage data caused after switching the computing cluster according to a second amount of depended data of the one or more to-be-duplicated data units, wherein the second amount of depended data includes a depended data volume between the one or more to-be-duplicated data units and other data units outside the target cluster; and
generating the bandwidth status data using the current bandwidth usage data and the changed bandwidth usage data.

4. The optimization method according to claim 3, wherein the bandwidth usage data includes sampling data of a bandwidth usage amount corresponding to a time point in a time period, and the bandwidth status data comprises a probability of full bandwidth.

5. The optimization method according to claim 4, wherein acquiring the current bandwidth usage data further comprises:
acquiring a current bandwidth usage amount; and
sampling the current bandwidth usage amount in a pre-determined time period to generate first sampling data, wherein
acquiring the changed bandwidth usage data further comprises:
generating second sampling data of a historical bandwidth usage amount corresponding to a time point in the time period according to historical data of the to-be-duplicated data units; and
generating the bandwidth status data using the current bandwidth usage data and the changed bandwidth usage data comprises:
adding the first sampling data and the second sampling data to generate third sampling data, and determining the probability of full bandwidth based on the third sampling data.

6. The optimization method according to claim 5, wherein the probability of full bandwidth is equal to a time length when the bandwidth in the third sampling data exceeds a bandwidth upper limit divided by a time length of the time period.

7. The optimization method according to claim 4, further comprising:
determining the probability of full bandwidth of a data migration solution according to a probability threshold of full bandwidth, and
rejecting the data migration solution, in response to the probability exceeding the probability threshold.

8. The optimization method according to claim 1, wherein before generating the plurality of data migration solutions, the method further comprises:
sorting the one or more target data units in a source cluster according to a size of the first amount of depended data.

9. The optimization method according to claim 8, wherein before sorting the one or more target data units in the source cluster according to the size of the first amount of depended data, the method further comprises:
acquiring the first amount of depended data according to historical data of the target data units.

10. The optimization method according to claim 8, before sorting the one or more target data units in the source cluster according to the size of the first amount of depended data, the method further comprises:
determining bandwidth status data between clusters in a case of full volume data migration; and
in response to the bandwidth status data failing to satisfy a bandwidth feasibility condition, ending the optimization method.

11. The optimization method according to claim 1, wherein generating the plurality of data migration solutions according to the principle further comprises:
duplicating all of a plurality of target data units at once;
duplicating some of the plurality of the target data units; or
duplicating, among the plurality of the target data units, a target data unit having a most amount of depended data.

12. The optimization method according to claim 1, further comprising:
determining duplication time for duplicating the one or more to-be-duplicated data units under a duplication transmission bandwidth condition according to data volume of the one or more to-be-duplicated data units, and wherein
performing the selection of the data migration solutions according to the bandwidth status data further comprises:
determining a data migration solution according to the bandwidth status data and the duplication time.

13-24. (canceled)

25. An optimization apparatus for data migration, comprising:
a memory storing a set of instructions; and
a processor configured to execute the set of instructions to cause the apparatus to:
generate a plurality of data migration solutions according to a principle, wherein the principle includes duplicating one or more target data units with a first amount of depended data to a target cluster as to-be-duplicated data units and switching a computing cluster, and the first amount of depended data include depended data volumes of the target data units;
for each of the data migration solutions, determine bandwidth status data between clusters after switching the computing cluster; and
perform a selection of the data migration solutions according to the bandwidth status data.

26-48. (canceled)

49. A non-transitory computer readable medium that stores a set of instructions that is executable by at least one processor of a computer system to cause the computer system to perform an optimization method for data migration, the method comprising:
generating a plurality of data migration solutions according to a principle, wherein the principle includes duplicating one or more target data units with a first amount of depended data to a target cluster as to-be-duplicated data units and switching a computing cluster, and the first amount of depended data include depended data volumes of the target data units;
for each of the data migration solutions, determining bandwidth status data between clusters after switching the computing cluster; and
performing a selection of the data migration solutions according to the bandwidth status data.

50. The non-transitory computer readable medium according to claim 49, wherein the one or more target data units belong to one or more target project units, and switching computing cluster comprises: switching computing tasks in the one or more target project units to the target cluster.

51. The non-transitory computer readable medium according to claim 49, wherein determining the bandwidth status data between the clusters after switching the computing cluster further comprises:
acquiring current bandwidth usage data, the current bandwidth usage data being bandwidth usage data before switching the computing cluster;
acquiring changed bandwidth usage data caused after switching the computing cluster according to a second amount of depended data of the one or more to-be-duplicated data units, wherein the second amount of depended data includes a depended data volume between the one or more to-be-duplicated data units and other data units outside the target cluster; and
generating the bandwidth status data using the current bandwidth usage data and the changed bandwidth usage data.

52. The non-transitory computer readable medium according to claim 51, wherein the bandwidth usage data includes sampling data of a bandwidth usage amount corresponding to a time point in a time period, and the bandwidth status data comprises a probability of full bandwidth.

53. The non-transitory computer readable medium according to claim 52, wherein acquiring the current bandwidth usage data further comprises:
acquiring a current bandwidth usage amount; and
sampling the current bandwidth usage amount in a pre-determined time period to generate first sampling data, wherein
acquiring the changed bandwidth usage data further comprises:
generating second sampling data of a historical bandwidth usage amount corresponding to a time point in the time period according to historical data of the to-be-duplicated data units; and
generating the bandwidth status data using the current bandwidth usage data and the changed bandwidth usage data further comprises:
adding the first sampling data and the second sampling data to generate third sampling data, and determining the probability of full bandwidth based on the third sampling data.

54. The non-transitory computer readable medium according to claim 53, wherein the probability of full bandwidth is equal to a time length when the bandwidth in the third sampling data exceeds a bandwidth upper limit divided by a time length of the time period.

55. The non-transitory computer readable medium according to claim 52, wherein the set of instructions is further executed to cause the system to:
determine the probability of full bandwidth of a data migration solution according to a preset probability threshold of full bandwidth, and
reject the data migration solution, in response to the probability exceeding the probability threshold.

56-72. (canceled)
